(19) United States
(12) Patent Application Publication
(10) Pub. No.: US 2014/0178035 A1
(43) Pub. Date: Jun. 26, 2014

(54) COMMUNICATING WITH DIGITAL MEDIA INTERACTION BUNDLES

(71) Applicant: Kindoma, Inc., Palo Alto, CA (US)

(72) Inventors: Rafael Antonio Ballagas, Palo Alto, CA (US); Mirjana Spasojevic, Palo Alto, CA (US); Manish Anand, Palo Alto, CA (US)

(73) Assignee: Kindoma, Inc., Palo Alto, CA (US)

(21) Appl. No.: 14/135,478

(22) Filed: Dec. 19, 2013

Related U.S. Application Data
(60) Provisional application No. 61/745,289, filed on Dec. 21, 2012.

(51) Int. Cl. G11B 27/031; H04N 9/87

(52) U.S. Cl. CPC G11B 27/031; H04N 9/87
USPC 386/230

(57) ABSTRACT

In general, embodiments of the present invention provide systems, methods and computer readable media for communication using interactive digital content. One aspect of the subject matter described in this specification can be embodied in systems, methods, and computer program products that include the actions of receiving an interaction bundle including digital media, at least one datastream representing an initiator's engagement with the digital media, and a first sequential log representing the initiator's interactions with a first client device; providing a player to render a playback presentation of the interaction bundle on a second client device; generating a recording by the player, the recording including at least one datastream representing the recipient's engagement with the playback presentation and a second sequential log representing the recipient's interactions with a second client device during rendering of the playback presentation; and generating a reaction bundle that includes the interaction bundle and the generated recording.

### FIELD

This specification relates to communication using interactive digital content.

### BACKGROUND

Digital media is data represented in digital (as opposed to analog) form. Examples of digital media include digital video, digital audio, and digital images. Computer technology such as the internet, web sites, and digital multimedia has made it possible to store, process, and distribute digital media for access on-demand by any consumer in possession of a digital device.

The increasing prevalence of digital media has broadened the ways content is authored and consumed. For example, digital content can be integrated with other types of digital media into a multi-media application that presents a user interface (UI) with which a consumer can interact. Electronic greeting cards, videos, and digital games are examples of content that is conventionally distributed to consumers as interactive multi-media applications.

Books, magazines, newspapers, and other types of traditional literature are now being published as digital media. For example, publishers have been publishing their books as electronic books (eBooks) that integrate a book's traditional printed words and illustrations with interactive elements such as hotspots, audio with synchronized text highlighting, video, and educational puzzles related to the content. Through applied effort, ingenuity, and innovation, solutions to improve such systems have been realized and are described in connection with embodiments of the present invention.

### SUMMARY

In general, embodiments of the present invention provide herein systems, methods and computer readable media for communication using interactive digital content.

In general, one aspect of the subject matter described in this specification can be embodied in systems, methods, and computer program products that include the actions of receiving an interaction bundle including digital media, at least one datastream representing an initiator's engagement with the digital media, and a first sequential log representing the initiator's interactions with a first client device; providing a player to render a playback presentation of the interaction bundle on a second client device; generating a recording by the player, the recording including at least one datastream representing the recipient's engagement with the playback presentation and a second sequential log representing the recipient's interactions with a second client device during the rendering of the playback presentation; and generating a reaction bundle that includes the interaction bundle and the generated recording.

These and other embodiments can optionally include one or more of the following features. The datastream representing the initiator's engagement with the digital media may represent at least one type of sensor input. The initiator's interactions with the first client device may include one or more of clicks, touches, text entry, pen or finger strokes, and page turns. The first client device and the second client device may be the same device. The player may be a component of a web service that executes within a browser hosted by the second client device. Providing the player may include downloading an application that executes locally on the second client device. The actions may further include storing the reaction bundle in a data store. The actions may further include receiving the reaction bundle; and providing a player to render a playback presentation of the reaction bundle on the first client device.

In general, one aspect of the subject matter described in this specification can be embodied in systems, methods, and computer program products that include the actions of generating a recording on a client device by a processor, the recording including at least one datastream representing an initiator's engagement with digital media and a sequential log representing the initiator's interactions with the client device; generating an interaction bundle including the digital media and the recording; and uploading the interaction bundle to an application server.

These and other embodiments can optionally include one or more of the following features. The actions may further include caching the interaction bundle locally on the client device. The actions may further include generating a playback presentation using the interaction bundle, the playback presentation including a synchronized playback of the digital media and the datastream; and displaying the playback presentation on the client device. The recording may represent a synchronous 2-way video chat. The recording may represent a whiteboard scenario. The sequential log may include a sequence of interaction events, each interaction event being associated with a timestamp attribute. Each interaction event may be represent as a set of key-value par formatted strings.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates an example system that can be configured to implement a sequence of events, at least some of which can be in response to user interactions with the system, that facilitate two-way communication by captured engagement with the digital content provided by digital media tent in accordance with some embodiments discussed herein;

FIG. 2 shows screenshots from an example UI for viewing a children's eBook and simultaneously recording interactions during the viewing in accordance with some embodiments discussed herein;

FIG. 3 illustrates examples of UI components that enable an initiator to control aspects of the recording according to various embodiments of the invention in accordance with some embodiments discussed herein;

FIG. 4 shows partial screenshots from an example UI during recording of the interactions of an initiator with a children's eBook in accordance with some embodiments discussed herein;

FIG. 5 is a flow diagram of an example method for generating a reaction bundle in accordance with some embodiments discussed herein;

FIG. 6 shows a screenshot of an example UI for viewing the recording component of an interaction bundle based on a children's eBook and simultaneously recording interactions during the viewing in accordance with some embodiments discussed herein;

FIG. 7 illustrates examples of a player embodiment that enables enforcement of access control before initiating video playback of an interaction bundle in accordance with some embodiments discussed herein;

FIG. 8 is a flow diagram of an example method for playback of a reaction bundle in accordance with some embodiments discussed herein;

FIG. 9 shows a partial screenshot from an example UI eBook page display during viewing a playback of a reaction bundle based on a children's eBook in accordance with some embodiments discussed herein; and

FIG. 10 depicts a user device in accordance with some embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Some eBooks can be customized. For example, an initiator can replace the default audio of the eBook with a recording of his/her own voice so that any recipient of the eBook would hear the initiator's voice reading to the recipient as the recipient pages through the eBook. In some embodiments, the recipient can be enabled to interact with the eBook itself and therefore able to leverage those interactions into a communication with the initiator who customized the eBook.

In this regard, described herein are examples of technologies relating to providing a framework for two-way communication based on captured engagement with shared digital multi-media through an interactive digital application.

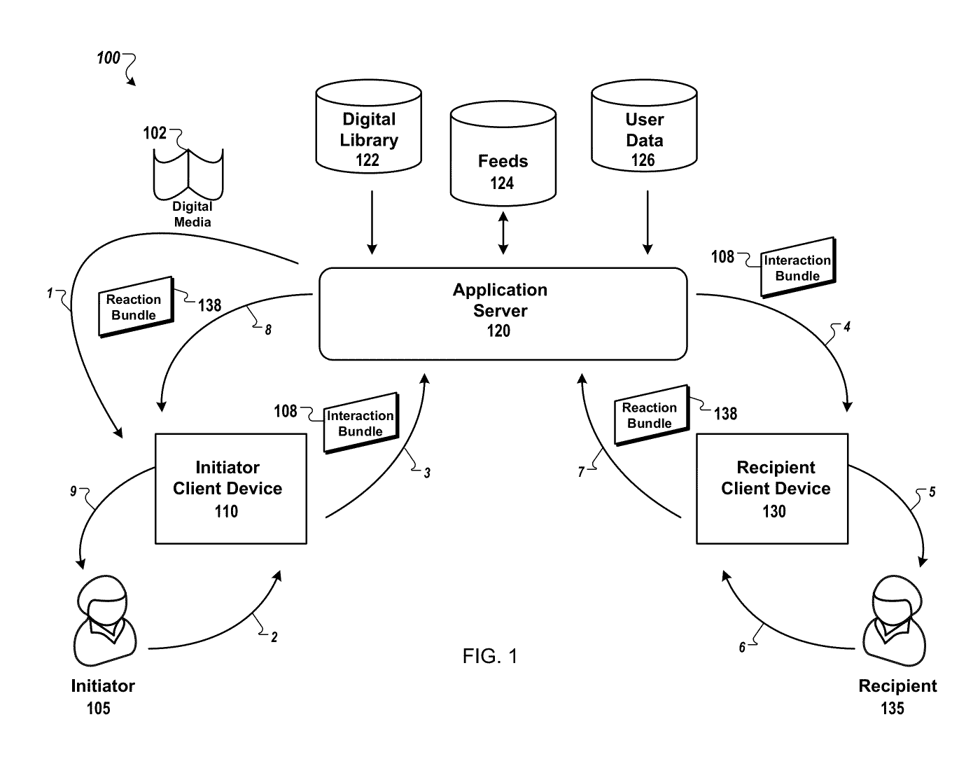

FIG. 1 illustrates an example system 100 that can be configured to implement a sequence of events, at least some of which can be in response to user interactions with the system, that facilitate two-way communication by captured engagement with the digital content provided by digital media (e.g., an eBook) 102. In embodiments, system 100 comprises an initiator client device 110 with which an initiator 105 interacts; a recipient client device 130 with which a recipient 135 interacts; one or more storage devices that may store a digital library 122, at least one feeds data repository 124, and at least one user data repository 126; and an application server 120 that exchanges data with the initiator client device 110, the recipient client device 130, and the storage devices.

In embodiments, the initiator 105 may select the digital media 102 from a collection of digital media stored and maintained by the system 100 in a digital library 122. Access to the digital media 102 is provided (step 1) to the initiator client device 110 from the application server 120. In some embodiments, access to the selected digital media 102 may be received by the initiator client device 110 from resources external to the system 100.

The system 100 can include a player that can be provided to the initiator client device 110 by the system 100. The player can configure the initiator client device 110 to provide a user interface (UI) through which the initiator 105 can view and interact with a presentation of the digital media 102. The player enables the initiator 105 to make a recording (step 2) of interactions with the presentation of the digital media 102. For example, in some embodiments, a grandmother may be the initiator 105, and may record her reading aloud a children's eBook 102 that she has selected to read to her grandchild, who may be located in another town or otherwise be remote from the grandmother. In a second example, the initiator 105 may be a tutor who is interacting about course work digital media with one or more students who may be remote from the tutor.

In some embodiments, the system 100 provides the player as a component of a web service that executes within a browser hosted by the initiator client device 110. In some embodiments, the player is provided by an application that is downloaded to the initiator client device 110 from the application server 120 and executed locally. In some other embodiments, the player is provided by the system 100 or an external source (e.g. an online marketing source), installed on the initiator client device 110, and executed locally as a client-side application.

A recording of interactions can include at least one recording of an engagement between the initiator 105, the digital media 102, and/or the client device 110. A recording of an engagement can be a datastream representing at least one type of sensor input. Examples of sensor input types can include audio/video; an accelerometer; a GPS; and/or a gyroscope.

A recording of interactions also can include a recording of initiator 105 interactions with the initiator client device 110. Examples of interactions with the initiator client device 110 include clicks, touches, text entry, pen or finger strokes, and page turns among other things. In embodiments, an initiator 105 optionally may record prompted interactions (e.g. “Can you find the frog?”); hints to scaffold the interactions of the recipient 135 (e.g. “Not quite. Try again!”); praise for the recipient 135 successfully completing a prompted interaction (e.g. “Good job!”); and encouragement or instruction for incorrectly completed tasks (e.g. “Good try, but that's not a frog. Here is the frog. [finger pointing to frog on the screen based on initiator's touch during the recording]”). In some embodiments, prompts may be recorded by the initiator or they may be generated by the system (e.g. popups, animations, highlights, and default recorded prompts).

In some embodiments, the recording of interactions may represent a whiteboard scenario. For example, a student needing help with his homework records an interaction bundle of himself interacting with the assignment. He takes a picture of his math homework assignment, circles the problem with which he's having trouble, and proceeds to write on a whiteboard screen the 3 steps that he took to solve the problem until he got stuck. He sends the recorded interaction bundle to a tutor service.

In some embodiments, a recording may be of a synchronous 2-way video chat. For example, a grandmother may initiate a call to a remote grandchild to read “‘Twas the Night Before Christmas” from an eBook on Christmas Eve. The grandmother activates the recording feature to record the call. During the session, the grandmother engages the grandchild by pointing to the pictures on the eBook pages and asking questions about each page, e.g., “Which reindeer is at the front of Santa's sleigh?” She also shakes her device to cause the grandchild's device to vibrate to emphasize Santa landing on the roof. The recording of the session consists of two video streams and two interaction streams from each side of the call interwoven together along with sensor readings (e.g., location and accelerometer) from both sides.

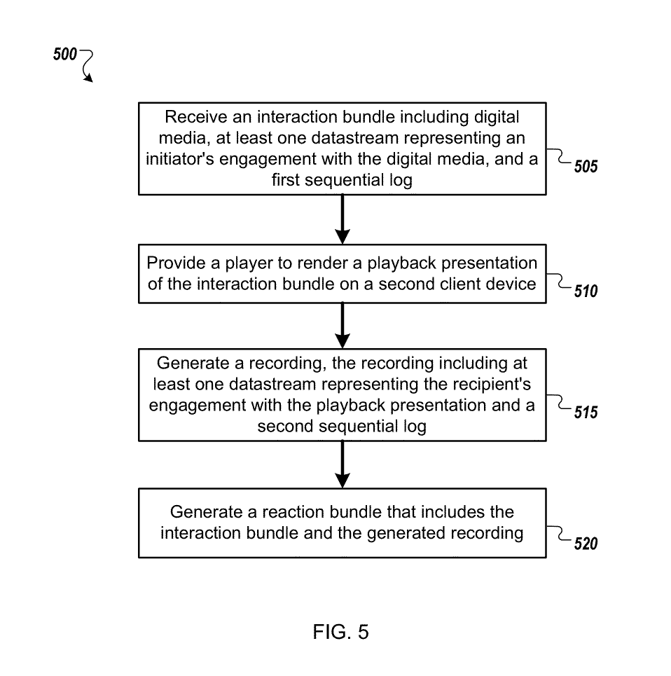

In embodiments, an interaction between the initiator 105 and the client device 110 is represented as an interaction event. The player generates an interaction log representing a sequential compilation of interaction events during the recording. The interaction log is described in detail below with reference to FIG. 5.

Once a recording is complete, an interaction bundle 108 is generated that can include the original media 102, the datastream representing the sensor recordings of the initiator's 105 engagement with the original media 102, and the interaction log representing the recording of the initiator's 105 interactions with the initiator client device 110. In some embodiments, local caching on the initiator client device 110 supports disconnected operations, and/or compression is used to optimize data storage on the client device 110. Referring to the synchronous 2-way video chat example above, in some embodiments, the grandmother may use the player to play back the recording of the session from the night before to a neighbor, who will see a playback of the video combined with the touch and gesture events from the screen just as if she had been looking over the grandmother's should as she read to the grandchild.

The interaction bundle 108 is uploaded (step 3) to the application server 120. In embodiments, the uploaded interaction bundle 108 is stored by the system 100. In some embodiments, the components of an interaction bundle 108 are stored in separate data repositories, each component being associated with identifiers representing the storage locations of the other components. For example, the sensor recording components and the interaction log may be stored in one or more feeds data repositories 124 along with a pointer to the original media 102 stored in a digital library 122. In some embodiments, compression is used to optimize data storage on the system 100.

In embodiments, an interaction bundle 108 can include data identifying both the initiator 105 who created the recordings and at least one designated recipient 135 for the bundle. In embodiments, the system stores and maintains user data 126 describing initiators and recipients of bundles. For example, in some embodiments, respective identifiers of individual users may be assigned to a shared household account that has its own identifier. Individuals may log into the system with their individual login credentials to access their shared household account, and the household account may be linked with one or more other household accounts as connections with which their household is authorized to exchange bundles. Thus, for example, a set of grandparents may identify the household account of their children and grandchildren as a connection. Communication between households uses the household identities instead of individual identities. An interaction bundle 108 may include respective identifiers for the initiator household and at least one recipient household that is registered as a connection, and the system may validate a received interaction bundle 108 based in part on the initiator household's connections list stored within a user data repository 126.

In embodiments, the application server 120 dispatches (step 4) an interaction bundle 108 to the recipient client device 130 that is associated with a designated recipient 135. In embodiments, the system 100 can be configured to retrieve the stored interaction bundle components and generate the interaction bundle 108 before dispatching the bundle to the recipient client device 130. In some embodiments, the system 100 can be configured to dispatch the interaction bundle 108 to the recipient client device 130 in response to receiving the interaction bundle 108 from the initiator client device 110. In some embodiments, compression is used to optimize network bandwidth during data transfer.

In embodiments, the system 100 can be configured to notify the designated recipient 135 that the interaction bundle 108 has been received from the initiator 105. For example, in some embodiments, a notification can be sent to the recipient 135 as an email while, additionally or alternatively, a notification can be posted as an alert, as a Short Message Service (SMS) message, a visual voicemail, or an internet chat message. In embodiments, the system 100 can be configured to send a notification to an application installed on the recipient client device 130 while, additionally or alternatively, a notification can be sent to an application executing within a browser hosted by the recipient client device 130.

In embodiments, the system 100 is configured to provide the recipient client device 130 with access to the interaction bundle 108 in response to receiving a request from the recipient 135. For example, in some embodiments, a recipient 135 may send a request for access to the interaction bundle 108 in response to receiving a notification that the interaction bundle 108 has been received by the system 100 from the initiator 105.

The system 100 can include a player that can be provided to the recipient client device 130 by the system 100. The player can configure the recipient client device 130 to provide a UI through which the recipient 135 can view and interact with a playback presentation of the interaction bundle 108 (step 5). In embodiments, the system 100 automatically generates the player using a template engine, accesses the stored components of the interaction bundle 108, and transmits the playback to the player executing within a browser hosted by the recipient client device 130. In some embodiments, the player can be provided by an application that is downloaded from the application server 120 to the recipient client device 130, and the playback of the interaction bundle executes locally on the recipient client device 130. Additionally or alternatively, the player can be provided by executing a client-side application that has been installed on the recipient client device 130.

The playback presentation of the interaction bundle 108 can include a synchronized playback of the original digital media 102, the sensor input recorded by the initiator 105, and the initiator's 105 recorded interactions with the initiator client device 110. In embodiments, a recording is made (step 6) at the recipient client device 130 of the recipient 135 consuming the interaction bundle 108 by interacting with the interaction bundle 108 playback. In embodiments in which the recipient client device 130 is configured with a small display screen, the playback presentation of the interaction bundle 108 can be configured to only include the initiator's 105 audio recording.

In embodiments, the recorded recipient's 135 interactions with the interaction bundle 108 playback can include one or more datastreams respectively representing one or more sensor inputs representing the recipient 135 engaging with the playback presentation. In embodiments, the recording made at the recipient client device also includes a second interaction log representing the recipient's 135 interactions with the recipient client device 130 (e.g. clicks, touches, text entry, pen or finger strokes, and page turns). For example, the recipient's interactions with the recipient client device 130 while consuming the interaction bundle 108 playback may include navigating to different parts of the playback by turning pages in the eBook 102

In embodiments, the recipient 135 can indicate, through the UI provided by the player, that the recording of the recipient 135 consuming the interaction bundle 108 is complete. In response to receiving this indication, the player generates a reaction bundle 138 that includes the interaction bundle 108, the sensor recordings of the recipient 135 consuming the interaction bundle 108, and the second interaction log. The second interaction log is described in detail below with reference to FIG. 5.

Referring to the math homework example described previously, a tutor reviewing the student's interaction bundle identifies the student's mistake at step 2. The tutor circles the mistake at step 2, then rewinds the recording back to step 2 and draws the correct step on the whiteboard. The tutor's reaction bundle is sent back to the student, who can review the tutor's recording to see where he went wrong and successfully complete his homework.

The reaction bundle 138 is uploaded (step 7) to the application server 120. In some embodiments, the uploaded reaction bundle 138 is stored by the system 100. The components of a reaction bundle 138 can be stored in separate repositories. For example, in some embodiments, the interaction bundle 108, the recipient's sensor recordings and the second interaction log can be stored in one or more feeds data repositories 124, each component being associated with a pointer to the original media 102 stored in a digital library 122. In some embodiments, compression is used to optimize data storage on the system 100.

In embodiments, the application server 120 dispatches (step 8) the reaction bundle 138 to the initiator client device 110. In some embodiments, the system 100 retrieves the stored reaction bundle components, which may be distributed according to a storage optimization scheme, and dynamically generates the reaction bundle 138 from the retrieved reaction bundle components before dispatching the reaction bundle 138 to the initiator client device 110. In some embodiments, the system 100 dispatches the reaction bundle 138 to the initiator client device 110 in response to receiving the reaction bundle 138 from the recipient client device 130.

In some embodiments, the system can be configured to notify the initiator 105 that a reaction bundle 138 has been received from the recipient 135. For example, in some embodiments, a notification can be sent to the initiator 105 as an email while, additionally or alternatively, a notification can be posted as an alert or as a Short Message Service (SMS) message, a visual voicemail, or an internet chat message. In embodiments, the system 100 can be configured to send a notification to an application installed on the initiator client device 110 while, additionally or alternatively, a notification can be sent to an application executing within a browser hosted by the initiator client device 110.

In embodiments, the system 100 is configured to provide the initiator client device 110 with access to the reaction bundle 138 in response to receiving a request from the initiator 105. For example, in some embodiments, an initiator 105 may send a request for access to the reaction bundle 138 in response to receiving a notification that the reaction bundle 138 has been received by the system 100 from the recipient 135.

The system 100 can include a player that can be provided to the initiator client device 110 by the system 100. The player can configure the initiator client device 110 to provide a UI through which the initiator 105 can view a playback presentation of the reaction bundle 138 (step 9). In some embodiments, the player is the same player used to record interactions included in an interaction bundle 108. In embodiments, the playback presentation of the reaction bundle 138 synchronizes the playback of the original media 102, the interactions recorded by the initiator 105, the interactions recorded by the recipient 135, and the sensor input recorded by the recipient 135.

In embodiments, the sequencing of the actions in the playback of the reaction bundle 138 is based on how the recipient 135 browsed the playback of the interaction bundle 108. For example, if the recipient 135 skips several pages ahead while viewing the playback of the interaction bundle 108, the playback of the reaction bundle 138 would follow the sequencing of the actions of the recipient 135, e.g. the initiator 105 can navigate to different parts of the reaction bundle 138 playback by turning pages in the eBook 102. In another example, the initiator 105 can navigate to different parts of the reaction bundle 138 playback by directly scrubbing (i.e. seeking through the playback presentation in either a forward or backward direction) the video of the recipient 135 in the player.

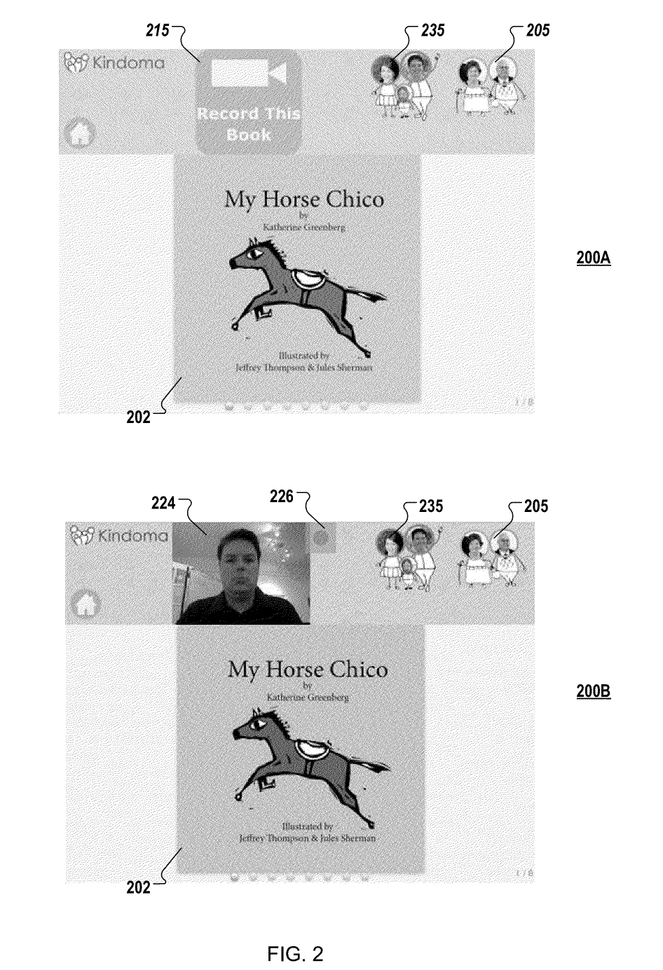

FIG. 2 shows screenshots from an example UI for viewing a children's eBook and simultaneously recording interactions during the viewing. The UI display includes an icon 205 representing the initiator household (grandparents, in this example) and an icon 235 representing the recipient household (grandchild and family). The UI display also includes a view 202 of the current page spread of the eBook that is being viewed. Screenshot 200A illustrates the UI before a recording is initiated, and further includes a button icon 215 that, in response to selection of the button icon 215 by an initiator 105, will display screenshot 200B with a camera preview. Screenshot 200B illustrates the UI before the initiation of a recording. The UI display includes an icon 226 for initiating recording of video input and recording the initiator's interactions with the playback of the eBook. The UI display also includes a preview video display window 224 showing the video input that is being recorded.

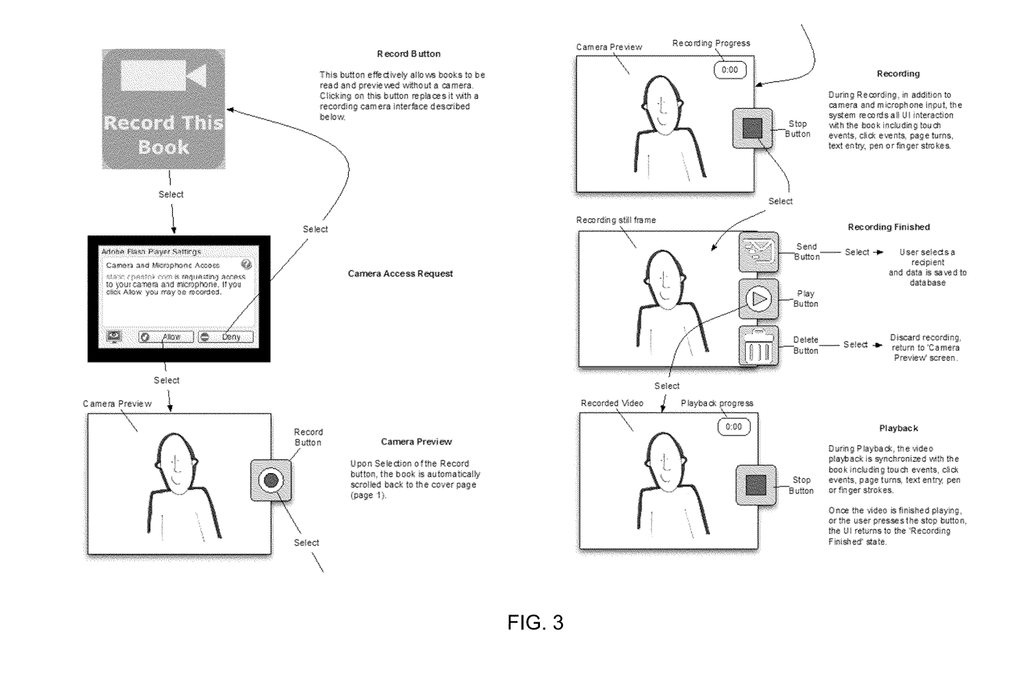

FIG. 3 illustrates examples of UI components that enable an initiator 105 to control aspects of the recording according to various embodiments of the invention. Illustrated is an example of a request for a user's permission before collecting sensor data on the client device. Exemplary types of sensors from which data are collected can include camera, microphone, GPS, accelerometer, gyroscope, and/or Bluetooth.

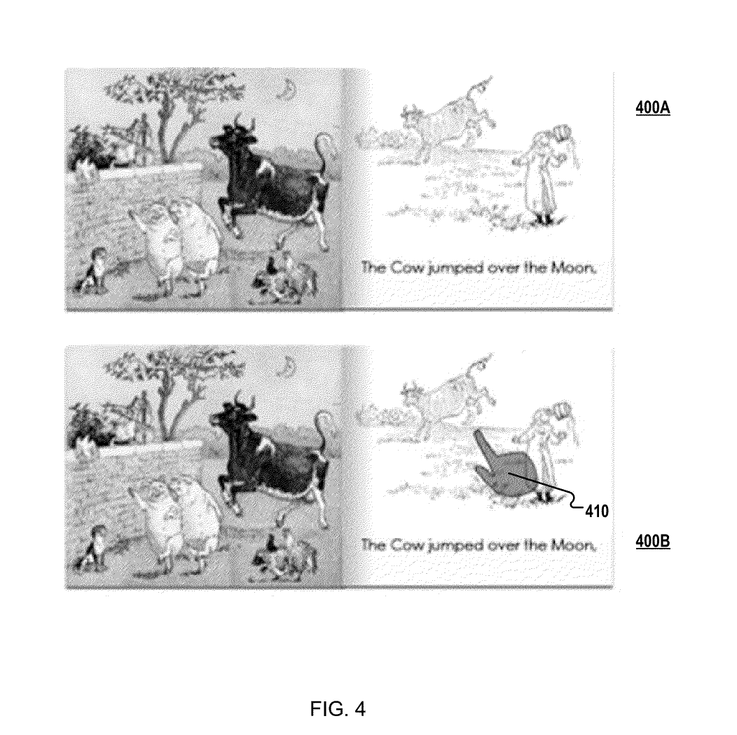

FIG. 4 shows partial screenshots from an example UI during recording of the interactions of an initiator with a children's eBook. Screenshot 400A illustrates a view of an eBook page during a recording. Screenshot 400B includes a view of the page with an overlay of a hand 410 that is generated as the initiator is, for example, clicking a mouse or touching the screen at that location on the page. This hand overlay is a representation of a user action, displayed to the initiator, of what will be seen by the recipient during playback of the interaction bundle 108.

FIG. 5 is a flow diagram of an example method 500 for generating a reaction bundle. For convenience, the method will be described with reference to a system that includes one or more computers and performs the method 500. Specifically, the method 500 will be described with respect to step 5 and step 6 at the recipient client device 130 of system 100.

The system receives 505 an interaction bundle that includes digital media 102, at least one datastream representing sensor input from the initiator's 105 engagement with the digital media 102, and a first sequential log representing the initiator's 105 interactions with the initiator client device 110.

In embodiments in which an initiator's 105 interactions with the initiator client device 110 are data received from a web or mobile client UI, each interaction can be recorded as one or more events using, for example, JavaScript event binding. Examples of recorded interactions can include, among other things, mouse events (e.g., mousedown, mousemove, mouseup, and mouseentered); touch events (e.g. touchdown, touchmove, touchup); sensor readings; and interaction with graphical widgets (e.g. selection of the “next page” button).

In embodiments, for example, each interaction event can be represented as a set of key-value pair (KVP) formatted strings as in the following example for a mousedown interaction event recorded during the rendering of an eBook:

{

timestamp:timeDelta,
type:“mouseDown”,
param1:coord.x,
param2:coord.y

}

In the above example, the timestamp attribute is a differential timestamp relative to when the record button icon 226 in the “camera preview” screen 200B was selected by the initiator 105. The type attribute describes the event type. Param1 and param2 are event-specific attributes that represent spatial coordinates. A particular event may include one or more event-specific attributes.

Referring again to the example of an eBook, the values of spatial coordinates (e.g. param1 and param2 in the example) of an interaction event can be normalized based on the size of the book spread image. Normalization allows an eBook to be displayed differently on different screens while the pointing interaction events are rendered in the correct area of each book page image so that semantic meaning is preserved. In embodiments, normalization of spatial coordinate values is achieved using the following algorithm (expressed in JavaScript):

function normalizedCoord(x,y,pg){

var ws, wi, hi, xo, img=$(‘.slide img’)[pg];
ws = $(window).width( ); // screen width
wi = $(img).width( ); // image width
hi = $(img).height( ); // image height
xo = (ws−wi)/2.0; // x offset
return {

x: (x−xo)/wi,
y: y/hi

}

}
function deNormalizedCoord(xn,yn,pg){

var ws, wi, hi, xo, img=$(‘.slide img’)[pg];
ws = $(window).width( ); // screen width
wi = $(img).width( ); // image width
hi = $(img).height( ); // image height
xo = (ws−wi)/2.0; // x offset
return {

x: xn*wi + xo,
y: yn*hi

}

}

In embodiments, during recording, an interaction log is written by sequentially compiling the interaction events into a KVP list. The KVP list interaction log is finished when the initiator 105 indicates the recording is complete (e.g. by selecting the stop recording button icon displayed on the UI or by navigating away from the recording view).

As previously described with reference to FIG. 1, the system can be configured to provide 510 a player that renders a playback presentation of the interaction bundle 108 on the recipient client device 130. In response to a selection from the UI by the recipient 135, the player renders a playback of the interaction bundle 108 while simultaneously generating 515 a recording of the recipient 135 and the recipient's 135 interactions with the playback presentation. The player synchronizes the rendering of the playback with the simultaneous recording of the recipient's 135 interactions.

In some embodiments, an interaction bundle 108 and/or a reaction bundle 138 may be made more browsable by displaying a summary timeline. For example, a grandmother reviewing some of her collection of recordings of her previous sessions reading to her grandchild may be able to preview the contents of each session by viewing the interactive summary respectively associated with the session. An exemplary session summary may display a timeline view of the session with annotations about which page was being discussed, who was talking, and who was interacting with the eBook. Particularly engaging moments in the timeline (e.g., moments including laughter) may be highlighted. The grandmother may select a particular moment from the timeline to start playback from that point in the session, and/or she may navigate the recording by scrubbing through the timeline.

In embodiments, the player can synchronize playbacks of the initiator's 105 interaction log and the initiator's recorded video using a basic dead-reckoning approach after starting the two playbacks at the same time. This type of approach can be vulnerable to synchronization issues when the video playback requires buffering delays.

In some embodiments, the player is instrumented to generate “playProgress” JavaScript events regularly during video playback. Each “playProgress” event represents the progress of the playback in units of time (e.g. seconds), enabling the interaction log playback to reset its playback clock regularly to match the playback clock of the video playback, even when buffering occurs. Below is some sample JavaScript code to synchronize video and interaction event playbacks based on “playProgress” events.

function processInterval( ){

interaction_playback_time = interaction_playback_time +

0.020

// the global index ensures that no events are repeated when

time is reset.

for(i=index; i<timing_data.length; i++){

if(timing_data[i].timestamp <

interaction_playback_time) {

processLoggedEvent(timing_data[i]);
index = i+1;

}else{

break

}

}
//play progress events happen about once every 0.5 seconds
//here we give an additional 0.25 seconds buffer
if( last_movie_time + 0.75 < interaction_playback_time){

// if video playback stops, cancel the timer
clearInterval(interaction_timer);

}

}
// handler for ‘playProgress’ javascript event from video
function onPlayProgress(current_movie_time) {

last_movie_time = current_movie_time;
clearInterval(interaction_timer);
interaction_playback_time = current_movie_time;
// setup a recurring timer to process logged events
interaction timer = setInterval(processInterval, 20);

}

In embodiments, the recipient 135 can interact with the initiator's playback presentation in a variety of ways. For example, the recipient 135 may navigate through an eBook by turning pages in the book. For each page turn made by the recipient 135, the player searches for a page turn event for the same page in the initiator's 105 interaction log. The search moves forward in time in the initiator's 105 interaction log for forward page turns, and moves back in time in the log for backward page turns. If a matching event to the recipient's 135 page turn is found in the initiator's 105 interaction log, the recorded video playback of the initiator 105 is resumed at the timestamp of the logged page turn event. This seeking interaction of the initiator's 105 interaction log is logged as an event in the second interaction log that represents the recipient's 135 interactions:

{

“timestamp”: timestamp,
“type”: “seek”,
“time”: “1:32”

}

If a matching event is not found in the initiator's 105 interaction log, then it is assumed that the initiator 105 did not visit this page, and the initiator's 105 recorded video is paused until the recipient 135 turns another page. This pause is logged as an event in the second interaction log:

{

“timestamp”: timestamp,
“type”: “pause”

}

If the recipient 135 resumes the paused initiator's 105 recorded video, the player will automatically turn the page in the playback to match the page to which the initiator 105 was referring in that section of the recording. For example, the recipient 135 may currently be on page 8 when resuming the initiator's 105 recording at a section of the video when the initiator 105 is discussing page 5. This example scenario can be logged as the following sequence of events in the second interaction log:

{

“timestamp”: timestamp,
“type”: “play”

},
{

“timestamp”:timestamp,
“type”: “pageturn”
“from”: 8
“to”: 5

}

In embodiments, the recipient 135 may navigate through the initiator's playback by directly scrubbing the video timeline. In response to a seek interaction from the recipient 135, the player searches the initiator's 105 interaction log to determine the correct page state of the initiator 105 by locating the nearest previous page turn event. If the initiator's current page after the page turn event is different from the current page of the recipient 135, a new page turn event is generated automatically and added to the recipient's 135 interaction log:

{

“timestamp”: timestamp,
“type”: “seek”,
“time”: “0:30”

}
{

“timestamp”:timestamp,
“type”: “pageturn”,
“from”: 5,
“to”: 2

}

In embodiments, the recipient's 135 sensor inputs and the second interaction log are recorded in a similar way to the recording of the initiator's 105 sensor inputs and the interaction log. When the recording is complete, the player generates 520 a reaction bundle 138 that includes the interaction bundle as well as the recipient's 135 sensor inputs and the second interaction log.

In embodiments, the second interaction log also can include reprocessed events from the initiator's 105 interaction log received in the interaction bundle 108. Each reprocessed event is given a new timestamp relative to the recipient's 135 recording and is saved to the second interaction log with a new event type.

For example, a mouse click may be represented in the initiator's 105 interaction log as the following formatted KVP list of events:

{

“timestamp”: “4.335”,
“type”: “mouseDown”,
“param2”: “0.1875”,
“param1”: “0.80325203252”

},
{

“timestamp”: “4.882”,
“type”: “mouseUp”,
“param2”: “0.1875”,
“param1”: “0.80325203252”

}

These events would be transcribed from the initiator's 105 interaction log into the second interaction log as follows:

{

“timestamp”: “2.111”,
“type”: “otherMouseDown”,
“param2”: “0.1875”,
“param1”: “0.80325203252”

},
{

“timestamp”: “2.658”,
“type”: “otherMouseUp”,
“param2”: “0.1875”,
“param1”: “0.80325203252”

}

The new timestamps represent the time of the events with respect to the recipient's 135 recording, and the new value for the event type attribute signifies that these events originated from the initiator 105 instead of the recipient 135. In some embodiments, an event binding may include an attribute indicating the actor responsible for originating the particular event.

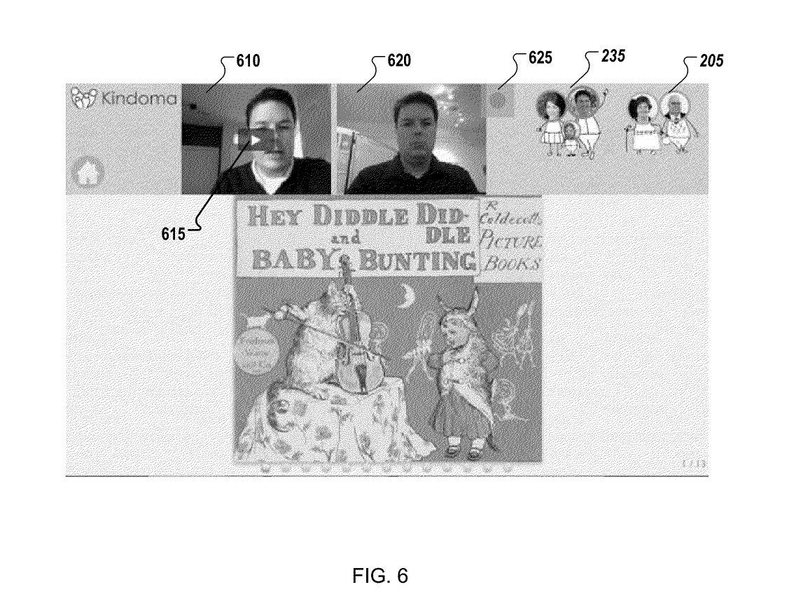

FIG. 6 depicts a screenshot of an example UI for viewing the recording component of an interaction bundle 108 based on a children's eBook and simultaneously recording interactions during the viewing. The UI display includes an icon 205 representing the initiator household (grandparents, in this example) and an icon 235 representing the recipient household (grandchild and family). The display includes a video playback window 620 for video input included in the interaction bundle 108 as well as a preview video display window 610 showing the video input that is being recorded during the viewing. In some embodiments, the video playback and video recording are synchronized by automatically starting the video playback if recording, or, conversely, automatically starting recording if video playback is started. There is a selectable icon associated with each of the video display windows. Icon 615, when selected, will play the recorded video input and auto-record video input of the viewer. Icon 625, when selected, will record video input of the viewer and auto-play the recorded video input.

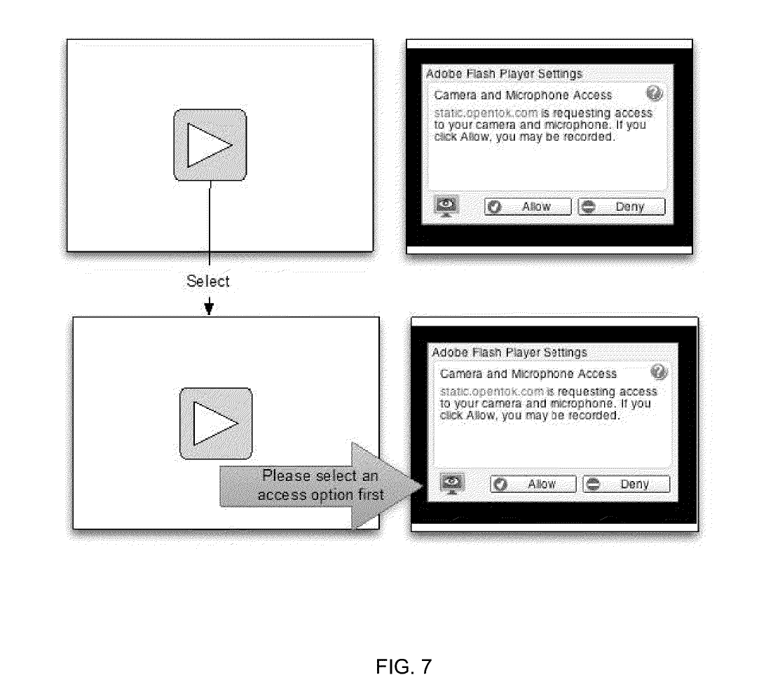

FIG. 7 illustrates examples of a player embodiment that enables enforcement of access control before initiating video playback of an interaction bundle 108. Some client devices, e.g. web browsers and mobile phones, require the use of camera and microphone to be authorized by the end user. In embodiments, if a recipient 135 selects play on a video before the authorization decision for the recipient client device 130 has been made, the player will display a visual reminder on the UI that an authorization decision is pending. Interacting with the UI, the recipient can deny the authorization request (and thus view the playback without recording), or the recipient can allow the authorization request (and thus record interactions during viewing of the playback).

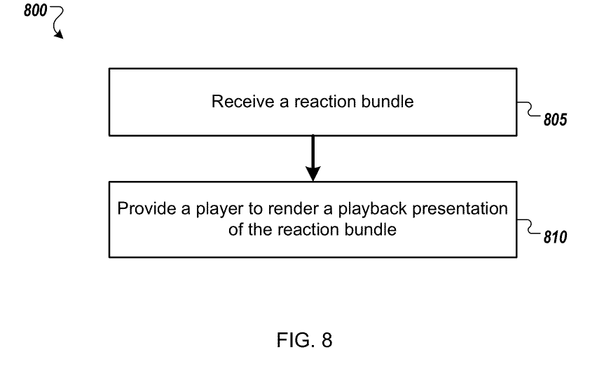

FIG. 8 is a flow diagram of an example method 800 for playback of a reaction bundle. For convenience, the method will be described with reference to a system that includes one or more computers and performs the method 800. Specifically, the method 900 will be described with respect to step 9 at the initiator client device 110 of system 100.

The system receives 805 a reaction bundle 138 that includes an interaction bundle, a recording of a recipient's interactions with a playback of the interaction bundle, and a second sequential log of the recipient's recorded interactions.

As previously described with reference to method 500, the system is configured to provide 810 a player to render a playback presentation of the reaction bundle 138 on the initiator client device 110. In embodiments, the player is the same player provided by the system to render an interaction bundle.

In embodiments, the playback of the video and the interaction events is synchronized using the same methods and algorithms that were described in reference to method 500. However, as described in reference to method 500, the second interaction log in the reaction bundle 138 contains additional types of events to encompass interaction events originating from both the initiator 105 and the recipient 135.

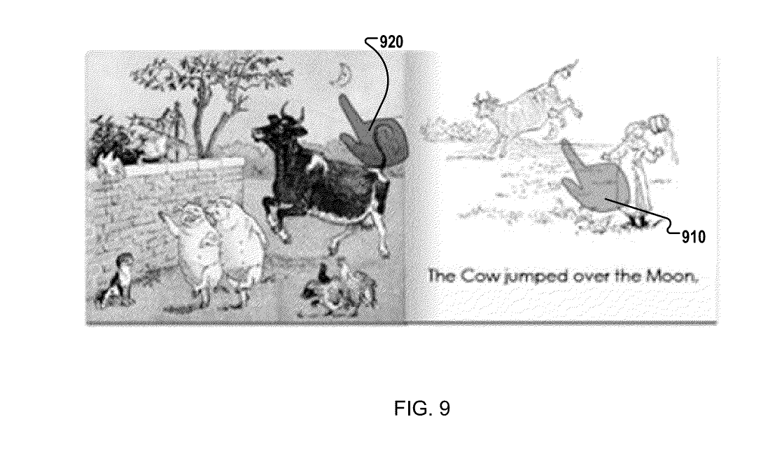

FIG. 9 shows a partial screenshot from an example UI eBook page display during viewing a playback of a reaction bundle 138 based on a children's eBook. The screenshot depicts a view of an eBook page with an overlay of a red hand 910 that represents the recipient 135 touching a location on the page and an overlay of a black hand 920 that represents the initiator 105 and was generated as the initiator 105 clicked a mouse at another location on the page.

In embodiments, the interactions in a reaction bundle playback are displayed using an initiator-centric perspective. Thus, the interaction log visualization during playback mimics the way the initiator 105 experienced preview feedback during the original recording (e.g. the black hand 920). The new interactions from the recipient 135 are displayed in a way that distinguishes them from the initiator's original interactions (e.g. the red hand 910).

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

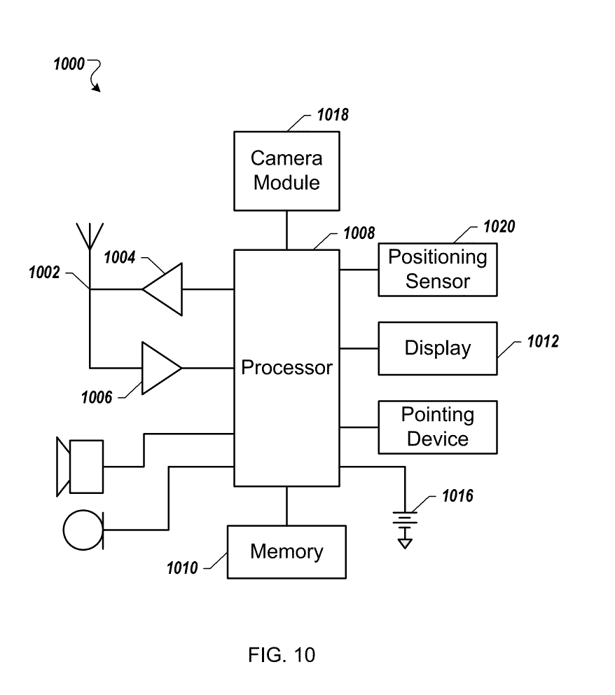

FIG. 10 depicts a user device 1000 in accordance with some embodiments. While it should be understood that a mobile telephone is exemplary of one type of user device that would benefit from some embodiments of the present invention, other types of user devices, such as portable digital assistants (PDAs), laptop computers, tablets, digital cameras, and others can employ embodiments of the present invention.

As shown in FIG. 1 and further discussed elsewhere herein, user device 1000 may be configured as a client device (e.g. the initiator client device 110 or the recipient client device 130) to communicate via a wireless communication network (such as a cellular network and/or a satellite network, a wireless local area network or the like) and, as such, may include one or more antennas 1002 in operable communication with transmitter 1004 and receiver 1006. The user device 1000 may further include a processor 1008 that provides signals to and receives signals from transmitter 1004 and receiver 1006, respectively.

Processor 1008 may include circuitry for implementing the functions of user device 1000. For example, processor 1008, such as its circuitry, may be comprised of a digital signal processor device, a microprocessor device, and various analog to digital converters, digital to analog converters, and other support circuits. Processor 1008, such as its circuitry, may be configured to operate one or more software programs, such as the player application, which may be stored in memory 1010, memory internal to the processor (not shown), external memory (such as, e.g., a removable storage device or network database), or anywhere else. For example, processor 1008 may be capable of operating a connectivity program, such as a conventional Web browser. The connectivity program may allow user device 1000 to transmit and receive content via a wide area network, such as the Internet, either in addition to or instead of communicating via a wireless communication network.

According to some exemplary aspects of embodiments of the present invention, processor 1008 may operate under control of a computer program product. For example, the memory 1010 can store one or more application programs or other software executed by the processor to control the operation of the user device, such as the player application. The computer program product for directing the performance of one or more functions of exemplary embodiments of the processor includes a computer-readable storage medium, such as the non-volatile storage medium (e.g., memory 1010), and software including computer-readable program code portions, such as a series of computer instructions forming the player application, embodied in the computer-readable storage medium.

As will be appreciated, any such computer program instructions may be loaded onto a computer or other programmable apparatus, e.g., processor 1008, to produce a machine, such that the instructions which execute on the computer or other programmable apparatus (e.g., hardware) create means for implementing the above-described functions. These computer program instructions may also be stored in a computer-readable memory (e.g., memory 1010) that may direct a computer or other programmable apparatus (e.g., processor 1008) to function in a particular manner, such that the instructions stored in the computer-readable memory produce an article of manufacture including instruction means which implement the functions described herein (see, e.g., FIGS. 7 and 8). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the player application functions described herein.

User device 1000 may comprise one or more user interfaces including output components, such as display 1012 and speaker 1022. The display 1012 may be configured to receive touch inputs. User device 1000 can also include one or more input components, such as pointing device 1014, camera module 1018, positioning sensor 1020, microphone 1024 and/or any other input component(s). The input and output components can be electrically coupled to processor 1008 as shown in FIG. 10. In some embodiments, display 1012 can have touch capabilities and act as both an input and output component. FIGS. 2-4, FIGS. 6-7, and FIG. 9, discussed herein, show some examples of displays that can be presented by user device 1000 having a touch or other type(s) of input/output components.

User device 1000 further includes a battery, solar cell(s), mains power connection and/or any other power source, represented herein as power source 1016, for powering the various elements that are required to operate user terminal 1000.

In exemplary embodiments, user device 1000 includes various types of specialized circuitry and other hardware that the player application can leverage and coordinate to solve technical problems and enhance the functionality of common devices. For example, user device 1000 can include input components, such as an image capturing element, which may be a camera, in communication with the processor 1008. The image capturing element may be any means for capturing an image, video or the like for storage, display or transmission. For example, in exemplary embodiments including camera module 1018, camera module 1018 may include a digital camera capable of forming a digital image file from a captured image. As such, camera module 1018 can include all hardware, such as a lens or other optical component(s), and software necessary for creating a digital image file from a captured image. Alternatively, camera module 1018 may include only the hardware needed to capture an image, while memory device 1010 of user device 1000 stores instructions for execution by processor 1008 in the form of software necessary to create a digital image file from a captured image. In an exemplary embodiment, camera module 1018 (like any other component discussed herein) may further include a dedicated processing element such as a co-processor which assists processor 1008 in processing image data and an encoder and/or decoder for compressing and/or decompressing image data.

User device 1000, including processor 1008, may be configured to determine the context of user device 1000 and, as such, may include one or more additional input components. For example, user device 1000 may further include positioning sensor 1020, which may be, for example, a global positioning system (GPS) module in communication with processor 1008. Positioning sensor 1020 may be any means, device or circuitry for locating the position of user device 1000, such as by means of GPS, an assisted global positioning system (Assisted-GPS) sensor, cellular triangulation, or the like.

Microphone 1024 is another example of a type of input component that may be included in user device 1000. Microphone 1024 can be used to receive sound and generate corresponding electrical signals.

In addition to display 1012, user device 1000 can include one or more other output components such as speaker 1022. Speaker 1022 can be used to emit audible sound.

The player application may be stored in memory 1010 and may be accessed or executed by processor 1008 to provide, among other things, the functionality described herein. The player application may be provided for free, for a subscription fee, for an upfront fee, or a combination thereof (e.g., some features free, some for an upfront fee and/or some for a subscription fee). When implemented on a touch screen device, some embodiments of the player application can enable user device 1010 to provide one-touch access to all the critical details about an interaction bundle 108 or a reaction bundle 138. The user can configure what details are critical, the application can be configured to determine what details are critical, and/or a backend system can determine what details are critical.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while examples involving books and multi-media applications are discussed herein, some embodiments can be configured to annotate and/or otherwise re-bundle and share any suitable type of media. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer program product, stored on a computer readable medium, comprising instructions that when executed on one or more computers cause the one or more computers to perform operations comprising:
receiving an interaction bundle including digital media, at least one datastream representing an initiator's engagement with the digital media, and a first sequential log representing the initiator's interactions with a first client device;
providing a player to render a playback presentation of the interaction bundle on a second client device;
generating a recording by the player, the recording including at least one datastream representing the recipient's engagement with the playback presentation and a second sequential log representing the recipient's interactions with a second client device during the rendering of the playback presentation; and
generating a reaction bundle that includes the interaction bundle and the generated recording.

2. The computer program product of claim 1, wherein the datastream representing the initiator's engagement with the digital media represents at least one type of sensor input.

3. The computer program product of claim 1, wherein the initiator's interactions with the first client device include one or more of clicks, touches, text entry, pen or finger strokes, and page turns.

4. The computer program product of claim 1, wherein the operations further comprise:
storing the reaction bundle in a data store.

5. The computer program product of claim 1, wherein the operations further comprise:
receiving the reaction bundle; and
providing a player to render a playback presentation of the reaction bundle on the first client device.

6. A system, comprising:
one or more computers and one or more storage devices storing instructions that are operable, when executed by the one or more computers, to cause the one or more computers to perform operations comprising:
receiving an interaction bundle including digital media, at least one datastream representing an initiator's engagement with the digital media, and a first sequential log representing the initiator's interactions with a first client device;
providing a player to render a playback presentation of the interaction bundle on a second client device;
generating a recording by the player, the recording including at least one datastream representing the recipient's engagement with the playback presentation and a second sequential log representing the recipient's interactions with a second client device during the rendering of the playback presentation; and
generating a reaction bundle that includes the interaction bundle and the generated recording.

7. The system of claim 6, wherein the datastream representing the initiator's engagement with the digital media represents at least one type of sensor input.

8. The system of claim 6, wherein the initiator's interactions with the first client device include one or more of clicks, touches, text entry, pen or finger strokes, and page turns.

9. The system of claim 6, wherein the first client device and the second client device are the same device.

10. The system of claim 6, wherein the player is a component of a web service that executes within a browser hosted by the second client device.

11. The system of claim 6, wherein providing the player comprises:
downloading an application that executes locally on the second client device.

12. The system of claim 6, wherein the operations further comprise:
storing the reaction bundle in a data store.

13. The system of claim 6, wherein the operations further comprise:
receiving the reaction bundle; and
providing a player to render a playback presentation of the reaction bundle on the first client device.

14. A computer-implemented method, comprising:
generating a recording on a client device by a processor, the recording including at least one datastream representing an initiator's engagement with digital media and a sequential log representing the initiator's interactions with the client device;
generating an interaction bundle including the digital media and the recording; and
uploading the interaction bundle to an application server.

15. The method of claim 14, further comprising:
caching the interaction bundle locally on the client device.

16. The method of claim 14, further comprising:
generating a playback presentation using the interaction bundle, the playback presentation including a synchronized playback of the digital media and the datastream; and
displaying the playback presentation on the client device.

17. The method of claim 14, wherein the recording represents a synchronous 2-way video chat.

18. The method of claim 14, wherein the recording represents a whiteboard scenario.

19. The method of claim 14, wherein the sequential log includes a sequence of interaction events, each interaction event being associated with a timestamp attribute.

20. The method of claim 19, wherein each interaction event is represented as a set of key-value pair formatted strings.
